(19) United States
(12) Patent Application Publication
(10) Pub. No.: US 2012/0136638 A1
(43) Pub. Date: May 31, 2012

(54) Process and device to determine a structure of an electric power distribution network

(75) Inventors: Philippe Deschamps, Le Pont de Claix (FR); Marie-Cécile Alvarez-Herault, Grenoble (FR)

(73) Assignee: Schneider Electric Industries SAS, Rueil-Malmaison (FR)

(21) Appl. No.: 13/373,301

(22) Filed: Nov. 10, 2011

(30) Foreign Application Priority Data
Nov. 25, 2010 (FR) 10 04580

(51) Int. Cl. G06F 7/60; G06G 7/62; G06G 7/50

(52) U.S. Cl. 703/2

(57) ABSTRACT

The method determines the structure of an electricity distribution system comprising a substation supplying a set of consumers via one or more feeders presenting one or more phases. It comprises the following steps:
receipt of first electric consumption information relative to each consumer of the set,
receipt of second electric consumption information relative to the feeders or to the phases of each feeder of the substation,
use of the first and second information comprising a computing phase to determine consumer subsets, within the set, the consumers of the same subset being supplied by the same given feeder and/or by the same given phase of a given feeder.

The device implements this method.

### BACKGROUND OF THE INVENTION

The present invention relates to the field of electric distribution on a power system, in particular a public grid. The invention relates to a method for determining the structure of an electricity distribution system. The invention also relates to a device for determining implementation of such a method. The invention also relates to a data recording medium and a computer program suitable for implementation of such a method.

### STATE OF THE ART

As represented in FIG. 1, on an electric power system 1, terminal distribution of electricity is performed in low voltage (LV) from MV/LV (Medium Voltage/Low Voltage) distribution substations 2 to low voltage consumers 5, in particular residential dwellings. A MV/LV substation 2 presents several feeders 3. Each feeder is deployed in a radial structure 4 presenting several single-phase or three-phase connections 6. This power system structure provides a certain number of consumers 5 with single-phase or three-phase power. A LV panel distributing power to the above-mentioned different feeders 3 is located in the MV/LV substation 2. There are typically between 1 and 8 feeders, which may be protected by fuses or circuit breakers.

Low-voltage power systems are dense, sometimes overhead, sometimes underground, mixing variable equipment and cables of variable ages. They are operated by electricity companies some of which have a history dating back over a century during which this power system has undergone modifications, extensions, and repairs. These power systems are technically simple, seldom subject to breakdowns and for this reason very often not documented, or at least very little and poorly.

Two factors have grafted themselves onto this landscape. Firstly, deregulation of the electricity sector imposes separation of the actors. Secondly, the electricity distribution systems belong to the electricity distributors who preserve a monopolistic status, but who are bound by national regulators. The latter impose objectives of service quality on their distributors, which objectives have to be measured, among other things, in time and number of supply interruptions seen by each of the connected consumers. These objectives are constraining and can give rise to penalties if they are not respected. The distributors consequently henceforth need to have a very great precision on the supply interruption data and precise information to better locate possible faults or bad functioning.

Furthermore, still within the scope of deregulation, a certain number of countries have decided to install smart meters which avoid the personnel having to do the rounds to read the meters. Depending on the regulatory contexts and also on the distributors, different architectures have been selected to perform the remote meter reading operations. In certain of these architectures, certain distributors have decided to install a data concentrator in each MV/LV distribution substation. This concentrator performs collection of the data from each of the meters assigned to it. The metering data are received via line carrier current or via radio electric means at regular frequency (about half an hour to one day). The concentrator then sends these measurements to a higher level via another means of communication. Metering data from each of the meters are therefore available in each MV/LV substation almost in real time.

Before the installation of smart meters, it was economically impossible to have access to the metering values of each of the meters almost in real time. Moreover, commonplace sensor technologies do not enable the current to be measured economically on each of the phases of each of the LV feeders of a MV/LV substation.

As seen in the foregoing, the structure of the power systems is sometimes poorly documented. Knowledge of these structures is however important. It therefore appears very interesting to be able to determine these structures in simple, economic and efficient manner. Such a knowledge of the power system in particular makes it possible to determine and to finely locate non-technical electrical current losses or bad functioning on the power system in simple and economic manner. Furthermore, it also enables imbalances of the power system to be diagnosed at the level of each feeder.

A method using numerous measuring apparatuses at different locations of a power system in order to determine the architecture of this power system is known from the document US 2010/0007219. Such a method is very costly as it requires numerous measuring devices at different levels in the power system. It also makes it possible to determine whether power is stolen from the power system.

A method for optimizing interpretation of data provided by an electric power system measuring or monitoring system is known from the document US 2007/14313.

### SUMMARY OF THE INVENTION

The object of the invention is to provide a method for determining the structure of an electric power system enabling the problems evoked in the foregoing to be remedied and improving known methods of the prior art. In particular, the invention proposes a method for determining of simple, economic and efficient structure.

According to the invention, a method for determining the structure of an electricity distribution system comprising a substation supplying a set of consumers via one or more feeders presenting one or more phases comprises the following steps:
receipt of first electric consumption information relative to each consumer of the set,
receipt of second electric consumption information relative to the feeders or to the phases of each feeder of the substation,
use of the first and second information comprising a computing phase to determine consumer subsets, within the set, the consumers of the same subset being supplied by the same given feeder and/or by the same given phase of a given feeder.

Advantageously, the computing phase is based on an assumption of energy conservation applied to the first and second information.

Preferably, the computing phase comprises computing of coefficients translating whether a consumer is connected or not to a feeder or to a phase.

Advantageously, a coefficient equal or substantially equal to 1 translates the fact that the consumer is connected to the feeder or to the phase and/or a coefficient equal or substantially equal to 0 translates the fact that the consumer is not connected to the feeder or to the phase.

Advantageously, the computing phase, in particular a computing phase of coefficients, uses an optimization method of least squares type.

Advantageously, the computing phase comprises computation of a confidence coefficient.

Preferably, the use step comprises a comparison phase of the results of the different iterations of the computing phase.

Preferably, it is concluded that a bad functioning or non-technical electrical current losses exist on the power system if the different results of the iterations of the computing phase are substantially different.

According to the invention, a data recording medium readable by a computer on which a computer program is recorded comprises software means for implementing the steps of the method as defined above.

According to the invention, a device for determining the structure of an electricity distribution system comprising a substation supplying a set of consumers via one or more feeders presenting one or more phases comprises hardware and/or software means for implementing the steps of the method as defined above.

Preferably, the hardware means comprise means for receiving power consumption information, in particular concerning receipt of first electric consumption information relative to each consumer of the set and receipt of second electric consumption information relative to the feeders or to the phases of each feeder of the substation, analysis or processing means comprising means for computing and means for restoring information, in particular information concerning subsets of consumers supplied by the same given feeder and/or by the same given phase of a given feeder.

According to the invention, a computer program comprises computer program encoding means suitable for execution of the steps of the method as defined above, when the program is executed on a computer.

### BRIEF DESCRIPTION OF THE DRAWINGS

The appended drawings represent, for example purposes, an embodiment of an electric power system comprising a device for implementing a method for determining according to the invention and a mode of execution of a method for determining according to the invention.

FIG. 1 shows an outline drawing of the general architecture of a LV electricity distribution system.

FIG. 2 shows a detailed drawing of an example of a LV electricity distribution system.

FIG. 3 shows a drawing of an example of a simplified electricity distribution system.

FIG. 4 is a flowchart of a mode of execution of a method for determining according to the invention.

### DETAILED DESCRIPTION OF PREFERRED EMBODIMENTS

The recent installation of smart electric consumption meters at the level of the final consumers implies the implementation of processing and communication means in the MV/LV distribution substations 1. This gives the opportunity of installing advanced processing functions in the MV/LV distribution substations 1, which was not possible beforehand. The method according to the invention makes it possible, in economic and automatic manner, to determine or to reconstitute the structure for the layout of a LV distribution system (i.e. to determine which consumer 5 is connected to which feeder or connection 3, or even to which phase), in particular from data and measurements available in the MV/LV distribution substation. This makes it possible to:
quantify and locate non-technical electrical current losses (in particular theft of power, and commercial database errors),
know the state of the losses on the LV system precisely and locate the feeders that contribute the most to these losses,
identify consumption imbalances per phase on the scale of each feeder, and/or
know exactly the number of clients impacted by a fault on a given LV feeder 3 so as to compute the precise SAIDI (system average interruption duration index) and SAIFI (system average interruption frequency index) performance indexes per year and per client.

Each consumer or final user 5 is equipped with a smart meter which enables consumption information to be transmitted regularly to the substation 2 to which it is connected. A database located in the substation contains the accounts of successive consumptions of each of the connected meters.

It is thus possible to define indexes representative of the consumption of each of the consumers (active and/or reactive and/or apparent energy, instantaneous active and/or reactive and/or apparent power, instantaneous active and/or reactive and/or apparent current, etc.).

The consumption measuring or metering system is installed in the substation 2 at the level of each feeder 3 or at the level of each phase of each feeder 3 enabling information homogeneous with the information measured by each of the meters to be measured, i.e. indexes representative of the consumptions (active and/or reactive and/or apparent energy, instantaneous active and/or reactive and/or apparent power, instantaneous active and/or reactive and/or apparent current, etc.).

In a preferred embodiment, the consumption data collected at the level of each consumer and in the substation 2 at the level of the feeders or of the phases are synchronized, i.e. they are relative to the same period in the case of an energy or to the same moment if a power or current intensity is involved in.

Whatever the type of consumer (three-phase or single phase), the latter is assigned to the feeder to which it is connected by means of the method according to the invention. Assignment to the corresponding phase is possible according to the type of information available.

If the meters of the three-phase consumers give three indexes representative of the consumptions corresponding to each phase, then assignment of each consumer to the phase or to the phases to which it is connected is possible.

If the meters of the three-phase consumers only give a global index representative of the global consumption of the consumer, then assignment of each consumer to the phase or to the phases to which it is connected may not be possible. Nevertheless, this assignment can be made possible by means of another device enabling the phases connected to the meters present at the level of the consumers to be identified.

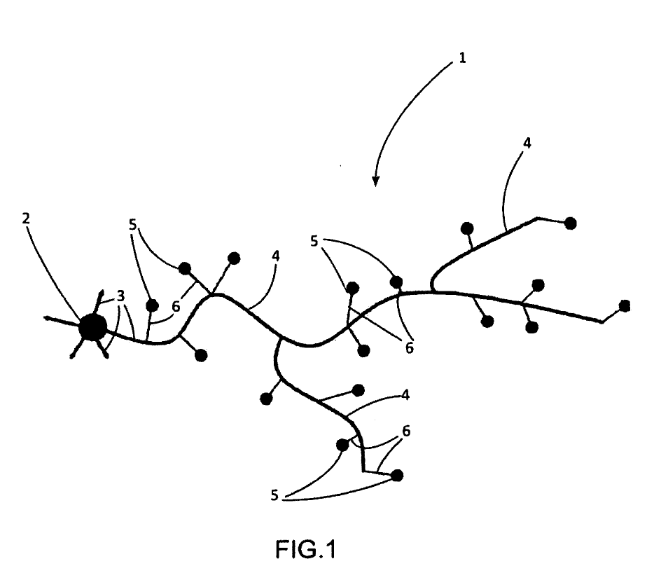

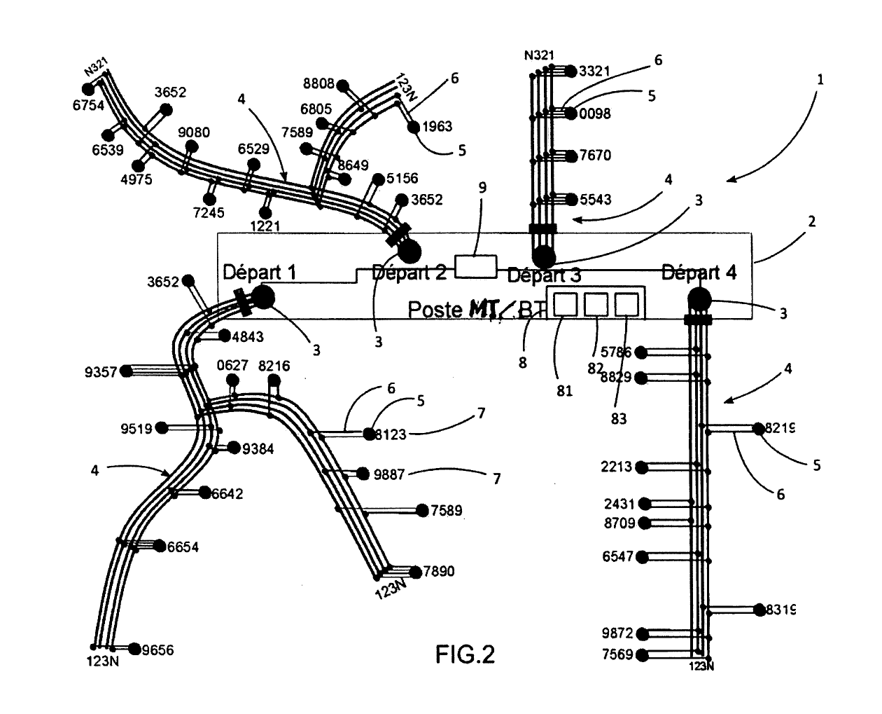

As represented in FIG. 2, on an electric power system 1, terminal electricity distribution is performed in low voltage (LV) from MV/LV distribution substations 2 to low voltage consumers 5, in particular residential dwellings. A MV/LV distribution substation 2 is the feeder of a power system structure presenting several three-phase lines 4, each connected by a connection or feeder 3 to the substation. This power system structure provides a certain number of consumers with single-phase or three-phase power (about 100). A LV panel distributing the power to the different feeders 3 is located in the MV/LV substation. There are typically between 1 and 8 feeders which may be protected by fuses or circuit breakers. In FIG. 2, each feeder comprises four electric conductors: the three phases each identified by the FIGS. 1, 2, 3 and the neutral identified by the letter N. The three-phase consumers are connected to each of the electric conductors and the single-phase consumers are connected to one of the phases and to the neutral. In the example of FIG. 2, the substation 2 comprises four low-voltage feeders 3. Each feeder supplies a certain number of single-phase and/or three-phase consumers. A s mart meter 7 identified by a reference proper to the distributor (four-figure number given as an example in FIG. 2) is assigned to each consumer. Each meter transmits consumption information item (for example active energy information) if it is single-phase and three consumption information items (for example active energy information) relative to each of the phases if it is three-phase. This information is transmitted to a device 8 for determining a power supply structure, for example located in the substation 2, by suitable communication means (by radio electric waves or by line carrier currents for example). Furthermore, a measuring system 9 measures consumption information (for example active energy information) on each feeder or on each phase of each feeder and also transmits this information to the device 8. This measuring system may use a wireless technology so as to simplify implementation on existing substations.

The determining device 8 comprises means 81 for receiving consumption information transmitted by the smart meters 7 and by the measuring system 9, analysis or processing means 82 of this information and possibly means 83 for delivering an analysis report, such as information transmission means or a communication interface, in particular visual and/or audio. These means 83 in particular enable a person in charge of management of the power system to receive information on the assumed structure of the power system by implementing the method for determining according to the invention.

The determining device 8 comprises hardware and/or software means enabling its operation to be controlled in accordance with the method which forms the subject of the invention. The software means can in particular comprise a computer program encoding means suitable for performing the steps of the method according to the invention, when the program is running on a computer. The software can be comprised in the analysis or processing means 82.

Starting off from the data described in the foregoing, the method for determining according to the invention assigns each of the meters to one of the feeders or to one of the phases of one of the feeders finding the right assignment combination. In other words, the method for determining determines subsets, from the whole set of consumers, each subset corresponding to all the consumers connected to the same feeders or to all the consumers connected to the same phase of the same feeder. The result can be presented in the form of a data table, as represented below for the example of the power system of FIG. 2, listing the feeders, phases and connected meters.

| Feeder 1 | | | Feeder 2 | | | Feeder 3 | | | Feeder 4 | | |
|---|---|---|---|---|---|---|---|---|---|---|---|
| Phase 1 | Phase 2 | Phase 3 | Phase 1 | Phase 2 | Phase 3 | Phase 1 | Phase 2 | Phase 3 | Phase 1 | Phase 2 | Phase 3 |

| Cpt 3652 | | | Cpt 3652 | | | Cpt 5543 | | Cpt 5786 | |
|---|---|---|---|---|---|---|---|---|---|
| | Cpt 4843 | | Cpt 5156 | | | Cpt 7670 | | Cpt 8829 | |
| Cpt 9357 | | | | | Cpt 8649 | Cpt 0098 | | | Cpt 8219 |
| | Cpt 0627 | | | Cpt 7589 | | Cpt 3321 | | Cpt 2213 | |
| Cpt 8216 | | | | Cpt 6805 | | | Cpt 2431 | | |
| | | Cpt 9519 | | Cpt 8808 | | | Cpt 8709 | | |
| | | Cpt 8123 | | | Cpt 1963 | | | Cpt 6547 | |
| | | Cpt 9384 | | | Cpt 1221 | | | | Cpt 8319 |
| | Cpt 9887 | | | | Cpt 6529 | | | Cpt 9872 | |
| | | Cpt 6642 | | | Cpt 7245 | | | Cp7569 | |
| Cpt 7589 | | | | | Cpt 9080 | | | | |

| | | |
|---|---|---|
| Cpt 6654 | | Cpt 4975 |
| Cpt 7890 | Cpt 3652 | |

| | | |
|---|---|---|
| Cpt 9656 | | Cpt 6539 |
| | Cpt 6754 | |

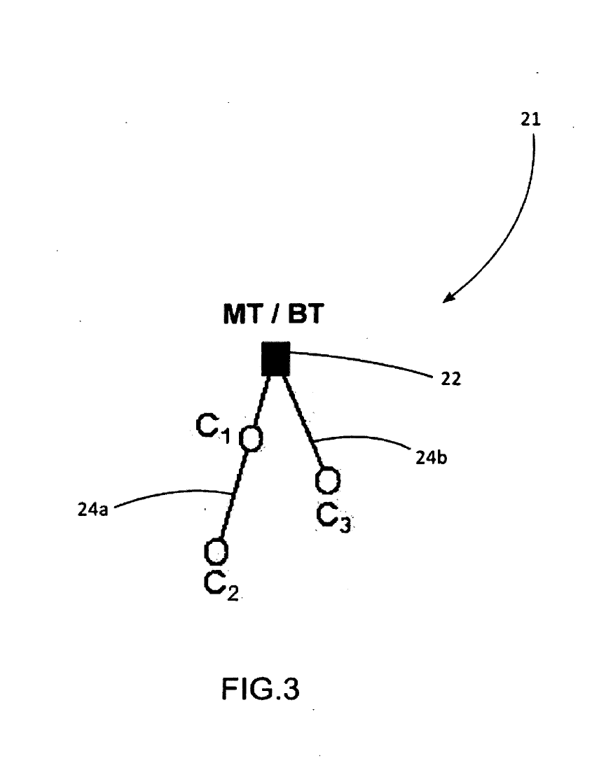

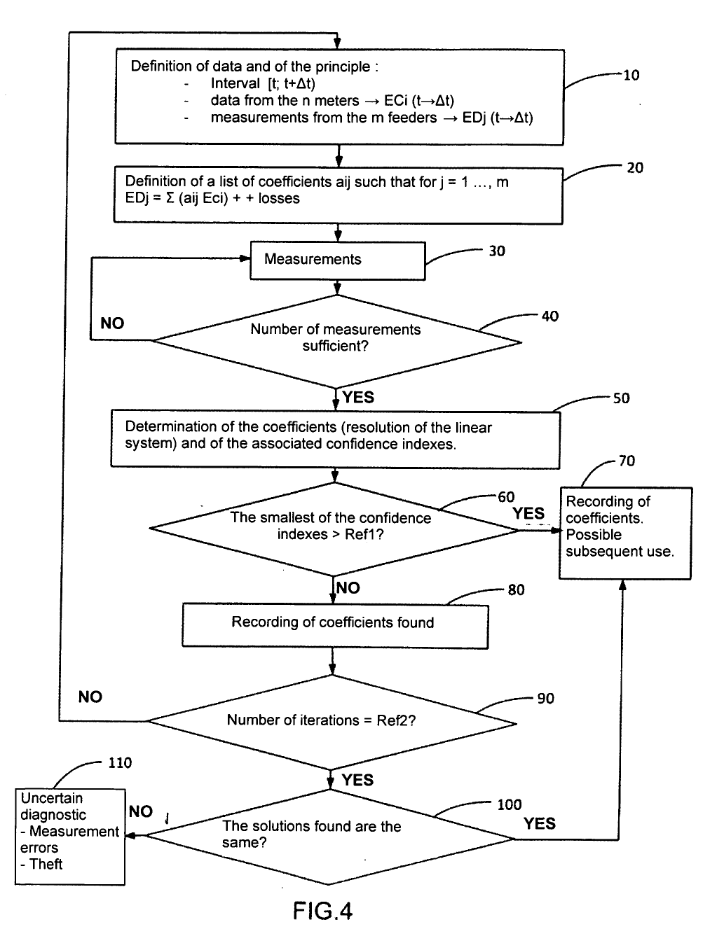

A method for executing the method for determining according to the invention is described in the following with reference to FIG. 4, the method for determining being applied to an example of power system 21 represented in FIG. 3. This power system 21 comprises a substation 22 having two feeders with lines 24a and 24b. The first feeder 24a comprises two consumers C₁ and C₂ on its line 24a and the second feeder comprises one consumer C₃ on its line 24b.

Henceforth, in the description of the mode of execution, we reason with active energies. A similar reasoning with other homogenous measurements is also possible and follows the same approach (reactive energy, apparent energy, active power, reactive power, apparent power, currents, in particular).

To simplify the description, it is assumed that all the consumers are three-phase. We thus reason by feeder looking at the total active energy consumed (on the 3 phases) measured on the feeder on the one hand and the active energy measured by the meters installed at the level of the consumers on the other hand. The reasoning is similar with single-phase consumers except that instead of reasoning by feeder we have to reason by phase.

In a first step 10, the main data of the power system and the principle of the method for determining are defined. The data of the following table are in particular defined:

| | |
|---|---|
| Total number of consumers | n (3 in the example of FIG. 3) |
| Total number of feeders or phases | m (2 in the example of FIG. 3) |
| Data collected at the level of each | Energy index E(t): this is an |
| consumer | accumulated energy consumed by |
| | each consumer at a time t. |
| Data collected at the level of each | Energy measurements over |
| feeder or phase | predefined time intervals |

For example, it is considered that the energy provided at the level of a feeder (or of a phase of a feeder) is equal, ignoring losses, to the sum of the energies consumed by the consumers connected to this feeder (or to the phase of this feeder). Thus, in a second step 20, a list of coefficients aᵢⱼ is defined with iε[1; n] corresponding to the number of meters and jε[a; m] corresponding to the number of feeders (in the example of FIG. 3, iε[1, 2, 3] and jε[a, b]) enabling this hypothesis to be modelled. These coefficients enable it to be translated to which feeder (or which phase) a given consumer is connected. If consumer i is connected to feeder j then aᵢⱼ=1 and if consumer i is not connected to feeder j then aᵢⱼ=0.

In the case of the power system of FIG. 3, a following list of coefficients (a₁ₐ, a_{1b}, a₂ₐ, a_{2b}, a₃ₐ, a_{3b}) is defined. In this example, implementation of the method for determining should result in the following solution a₁ₐ=1, a_{1b}=0, a₂ₐ=1, a_{2b}=0, a₃ₐ=0, a_{3b}=1.)

We define:

E_{Dj}(t→Δt)=Energy consumed on the whole the feeder j over the time period [t;t+Δt],

E_{Ci}(t→t+Δt)=Energy consumed by the consumer i over the time period [t;t+Δt],

Losses_{Dj}(t→t+Δt)=Energy lost on the feeder j over the time period [t;t+Δt].

The energy conservation is therefore translated for the different feeders j by the following formulas:

$${E}_{Dj} ( t \to Δ t ) = {\sum }_{i = 1}^{n} {a}_{ij} \times {E}_{Ci} ( t \to Δ t ) + {Losses}_{Dj} ( t \to Δ t )$$

$$with j ∈ [ a ; m ]$$

In the example of FIG. 3, the energy conservation is therefore translated for feeders a and b by the following formulas:

E_{Da}(t→Δt)=a₁ₐ×E_{C1}(t→Δt)+a₂ₐ×E_{C2}(t→Δt)+a₃ₐ×E_{C3}(t→Δt)+Losses_{Da}(t→Δt)

E_{Db}(t→Δt)=a_{1b}×E_{C1}(t→Δt)+a_{2b}×E_{C2}(t→Δt)+a_{3b}×E_{C3}(t→Δt)+Losses_{Db}(t→Δt)

In a third step 30, we perform a series of measurements at the level of the meters of each consumer and at the level of the feeders or phases in the substation 22 during defined periods or at defined times.

When the example of FIG. 3, let us assume that an energy measurement is made from 7 h to 7 h30 at the level of each consumer and at the incomer of each feeder. The results are represented in the following table.

| E_{C1}(7 | E_{C2}(7 | E_{C3}(7 | E_{Da}(7 | E_{Db}(7 |
|---|---|---|---|---|
| h→7 h 30) | h→7 h 30) | h→7 h 30) | h→7 h 30) | h→7 h 30) |
| 20 Wh | 30 Wh | 100 Wh | 52 Wh | 103 Wh |

An example of a digital application enables the proposed equation to be verified.

By multiplying the energies of the consumers by the corresponding coefficient (0 or 1), we obtain:

a₁ₐ×E_{C1}+a₂ₐ×E_{c2}+a₃ₐ×E_{C3}=1×20+1×30+0×100=50

a_{1b}×E_{C1}+a_{2b}×E_{C2}+a_{3b}×E_{c3}=0×20+0×30+1×100=100

whence

E_{Da}=52=50+2

E_{Db}=103=100+3

The above modelling is verified with the losses of feeder a equal to 2 Wh and the losses of feeder b equal to 3 Wh.

In a fourth step 40, we test whether we have sufficient measurements to solve the above-mentioned equations. If this is not the case, we loop back to step 30. If this is the case, we go on to a step 50.

In this step, the value of the coefficients a₄ in fact has to be found to be able to write the energy conservation formulas.

In the example of FIG. 3, if a single measurement is made at the level of each feeder and at the level of the consumers and the losses are ignored, then we have 2 equations for 6 unknowns:

$$52 ≅ {a}_{1 a} \times 20 + {a}_{2 a} \times 30 + {a}_{3 a} \times 100$$

$$100 ≅ {a}_{1 b} \times 20 + {a}_{2 b} \times 30 + {a}_{3 b} \times 100$$

$$whence$$

$${a}_{1 a} ≅ \frac{52 - ( {a}_{2 a} \times 30 + {a}_{3 a} \times 100 )}{20}$$

$${a}_{1 b} ≅ \frac{100 - ( {a}_{2 b} \times 30 + {a}_{3 b} \times 100 )}{20} .$$

The value of a₁ₐ and of a_{1b} cannot be determined as we do not know the value of the coefficients (a₂ₐ, a_{2b}) and (a₃ₐ, a_{3b}). We therefore need two other sets of energy measurements at the level of each meter and at the level of each feeder, for example on the time intervals from 7 h30 to 8 h and 8 h to 8 h30.

Examples of sets of measurements are given in the table below.

| Interval | E_{C1} | E_{C2} | E_{C3} | E_{Da} | E_{Db} |
|---|---|---|---|---|---|
| 7 h→7 h 30 | 20 Wh | 30 Wh | 100 Wh | 52 Wh | 103 Wh |
| 7 h 30→8 h | 10 Wh | 50 Wh | 50 Wh | 63 Wh | 51 Wh |
| 8 h→8 h 30 | 30 Wh | 75 Wh | 130 Wh | 107 Wh | 135 Wh |

The number of measurements being sufficient, the value of the coefficients (a₁ₐ, a_{1b}, a₂ₐ, a_{2b}, a₃ₐ, a_{3b}) T for example by means of a calculation described further on.

If we generalize to a case of n meters and m feeders, with a single set of measurements, we have m equations with n×m unknowns. We therefore need n sets of measurements to be able to solve the equations.

In a fifth step 50, the equations mentioned above are solved and the coefficients aᵢⱼ are determined.

The losses in the power system being low (less than 4%), the sum of the active energies of the consumers of a given feeder is practically equal to the sum of the energy consumed by the feeder, as seen above. Advantageously, one of the methods applied is for example minimization of the least squares of the difference between the consumed energy measured at the level of a given feeder and the sum of the consumed energies measured at the level of all the meters of the consumers connected to the substation, the consumed energies measured at the level of all the meters of the consumers being weighted by the previously defined coefficients.

The coefficients aᵢⱼ therefore have to be found such that the sum S is minimal, S being equal to:

$$\sqrt{{\sum }_{j = 1}^{m} {\sum }_{i = 1}^{n} {[ ( {\sum }_{i = 1}^{n} {a}_{ij} \times {E}_{Ci} measured ( t \to Δ t ) ) - {E}_{Dj} measured ( t \to Δ t ) ]}^{2}}$$

Which means that in the case of the example of the power system of FIG. 3, the coefficients a₁ₐ, a_{1b}, a₂ₐ, a_{2b}, a₃ₐ, a_{3b} have to be found such that the sum S is minimal, S being equal to s=\sqrt{s₁ₐ²+s_{1b}²+S₂ₐ²+s_{2b}²+s₃ₐ²+s_{3b}²} with

$$\{ \begin{matrix}{S}_{1 a} = {a}_{1 a} \times 20 + {a}_{2 a} \times 30 + {a}_{3 a} \times 100 - 52 \\ {S}_{1 b} = {a}_{1 b} \times 20 + {a}_{2 b} \times 30 + {a}_{3 b} \times 100 - 103 \\ {S}_{2 a} = {a}_{1 a} \times 10 + {a}_{2 a} \times 50 + {a}_{3 a} \times 50 - 63 \\ {S}_{2 b} = {a}_{1 b} \times 10 + {a}_{2 b} \times 50 + {a}_{3 b} \times 50 - 51 \\ {S}_{3 a} = {a}_{1 a} \times 30 + {a}_{2 a} \times 75 + {a}_{3 a} \times 130 - 107 \\ {S}_{3 b} = {a}_{1 b} \times 30 + {a}_{2 b} \times 75 + {a}_{3 b} \times 130 - 135\end{matrix}$$

Convergence of the algorithm is ensured by several means. To facilitate its convergence, several constraints can be added such as for example:
In theory the value of the coefficients is 0 or 1, but in the case where a resolution technique in real numbers is used, the method computes real values in particular to find a solution in spite of measurement errors and energy losses. It is thus necessary to limit the solution sought for. This is translated by the following system:

−ε%≦aᵢⱼ≦(1+ε%) with jε[1;m] and iε[1;n]
ε% represents a value enabling possible measuring and computing errors to be taken into account which is to be defined according to the equipment used and to the losses. 15% is a usable order of magnitude.
   If a consumer i, Cᵢ, is connected to the feeder j, Dⱼ, then it cannot be connected to another feeder. This constraint is translated by the following system:

$$∀ i ∈ [ 1 ; n ] , {\sum }_{j = 1}^{m} {a}_{ij} = 1$$

Confidence indexes are defined:
On completion of the previous computation, coefficients aᵢⱼ with a value comprised between −ε% and (1+ε%) have been obtained.

In the case of the example dealt with, we obtain: (a₁ₐ, a_{1b}, a₂ₐ, a_{2b}, a₃ₐ, a_{3b})=(0.625, 0.375, 1, 0, 0.075, 0.925). It can be observed that the values of the coefficients (a₁ₐ, a_{1b}) are not close to 0 for 1 like the other coefficients. The results may therefore not be reliable and it is therefore necessary to check these results by applying the algorithm again but on another set of data. This reliability can be checked by reproducing steps 30 to 50 several times on other sets of data measured at other times, in particular other times of the day or during another day or month.

In this step 50, confidence indexes are calculated.

To make the aᵢⱼ integers, rounding up to the closest integer is performed.

An aᵢⱼ very close to 0 (for example 0.05) can clearly be identified as 0. Likewise an aᵢⱼ very close to 1 (for example 1.02) can be identified as 1.

The closer aᵢⱼ is to 0.5, the more ambiguous the assignment. Whence the necessity of defining a confidence index which translates the distance of the coefficients aᵢⱼ with respect to 0.5.

A possible definition of the confidence indexes is:

$${Ind}_{ij} = \frac{\vert 0.5 - {a}_{ij} \vert}{0.5} \times 100 , expressed in \%$$

In a sixth step 60, these confidence indexes are tested. Obtaining a poor confidence index (less than Ref1) translates either measurement errors or a dependence of the retained equations or the presence of an additional consumption on the power system (theft, abnormal losses . . . ). If the least good of the confidence indexes is higher than a predefined value Ref1, then the results of the different coefficients aᵢⱼ determining the structure of the power system, i.e. the connections between the feeders and the consumers, are recorded in a step 70. If the least good of the confidence indexes is not higher than the predefined value Ref1, then we go on to a step 80 in which the coefficients aᵢⱼ found are stored and the previous steps 10 to 80 are reiterated until the number of iterations is equal to a predefined value Ref2.

This is tested in step 90. In the case where the number of iterations is equal to the value Ref2, we go on to a step 100 in which it is tested whether the different coefficients found and installed in the successive steps 80 are the same or similar. If this is the case, we loop back to step 60. If this is not the case, we go on to a step 110 in which it is concluded that measuring errors or non-technical electrical current losses on the power system exist.

By executing the algorithm several times (the number of iterations being fixed by the user), the power system configurations obtained on output can be compared. If they are all identical, it can be admitted that the solution found corresponds to reality. If this is not the case, the diagnostic is uncertain. The presence of non-technical electrical current losses is then greatly probable. So long as the number of iterations is less than a predefined value Ref2, steps 10 to 80 are reiterated.

By again taking the example of the power system of FIG. 3, we obtain as values of the coefficients: (a₁ₐ, a_{1b}, a₂ₐ, a_{2b}, a₃ₐ, a_{3b})=(0.625, 0.375, 1, 0, 0.075, 0.925). The coefficients a₁₁ and a₁₂ were then not reliable.

The data set of the table below is now considered and computation step 50 is restarted.

| Interval | E_{C1} | E_{C2} | E_{C3} | E_{Da} | E_{Db} |
|---|---|---|---|---|---|
| 7 h→7 h 30 | 20 Wh | 30 Wh | 100 Wh | 52 Wh | 103 Wh |
| 16 h→16 h 30 | 10 Wh | 10 Wh | 40 Wh | 21 Wh | 41 Wh |
| 20 h→20 h 30 | 50 Wh | 10 Wh | 5 Wh | 62 Wh | 5.5 Wh |

We find: (a₁ₐ, a_{1b}, a₂ₐ, a_{2b}, a₃ₐ, a_{3b})=(1, 0.9932, 0, 0, 0.0068, 1). The result is very reliable. By taking another set of measurements, the reliability of the result can be increased.

The value Ref1 is for example equal to 80%.

The value Ref 2 is the number of iterations made before considering that the system cannot converge due to an external problem. The number of iterations Ref2 increases the possibility of convergence but on the other hand increases the resolution time and the required historization capacity.

In other embodiments, if the consumers are also electricity producers, assignment of each consumer to the phase or phases to which it is connected is only possible if the production information is known, i.e. the meter must not only transmit the information relative to consumption, but also to production. It is in fact necessary to know which information is relative to production and which information is relative to consumption.

The above description makes reference to MV/LV substations, however the invention also applies to substations or installations with low voltage (LV) only.

1. A method for determining the structure of an electricity distribution system comprising a substation supplying a set of consumers via one or more feeders presenting one or more phases, said method comprising:
receiving electric consumption information relative to each consumer of the set,
receiving second electric consumption information relative to the feeders or to the phases of each feeder of the substation,
using the first and second information by computing to determine consumer subsets, within the set, the consumers of the same subset being supplied by the same feeder and/or by the same phase of a feeder.

2. The method for determining according to claim 1, wherein the computing is based on an assumption of energy conservation applied to the first and second information.

3. The method for determining according to claim 1, wherein the computing comprises computing of coefficients translating whether a consumer is connected or not to a feeder or to a phase.

4. The method for determining according to claim 3, wherein a coefficient equal or substantially equal to 1 translates the fact that the consumer is connected to the feeder or to the phase, and/or a coefficient equal or substantially equal to 0 translates the fact that the consumer is not connected to the feeder or to the phase.

5. The method for determining according to claim 3, wherein computing of coefficients, uses an optimization method of least squares type.

6. The method for determining according to claim 3, wherein computing comprises computing of a confidence coefficient.

7. The method for determining according to claim 1, wherein using the information comprises a comparison phase of the results of the different iterations of the computing phase.

8. The method for determining according to claim 7, wherein different results of the iterations of the computing phase indicate that dysfunctioning or non-technical electrical current losses exist on the power system.

9. A data recording medium readable by a computer on which a computer program is recorded, said program comprising software means for implementing the method according to claim 1.

10. A device for determining the structure of an electricity distribution system comprising a substation supplying a set of consumers via one or more feeders presenting one or more phases, said device comprising hardware means and/or software for implementing the method according to claim 1.

11. The device according to claim 10, wherein the hardware means comprise means for receiving power consumption information concerning receipt of first electric consumption information relative to each consumer of the set and receipt of second electric consumption information relative to the feeders or to the phases of each feeder of the substation, analysis or processing means comprising means for computing and means for restoring information concerning subsets of consumers supplied by the same feeder and/or by the same phase of a feeder.

12. A computer program comprising computer program encoding means for execution of the method according to claim 1, when the program is executed on a computer.
